(19) United States
(12) Patent Application Publication
(10) Pub. No.: US 2009/0021070 A1
(43) Pub. Date: Jan. 22, 2009

(54) CHAIR BACKREST MOUNTING BRACKET

(76) Inventor: Shun Hwong, Taipei (TW)

Correspondence Address: SCHMEISER, OLSEN & WATTS, 22 CENTURY HILL DRIVE, SUITE 302, LATHAM, NY, 12110, US

(21) Appl. No.: 11/778,879

(22) Filed: Jul. 17, 2007

(51) Int. Cl. F16B 12/00; A47C 31/00

(52) U.S. Cl. 297/463.1

(57) ABSTRACT

A chair backrest mounting bracket includes a middle fixing section made of a material with high rigidity and having an axially extended and internally threaded central mounting hole, the middle fixing section being connectable to a backrest support of a chair by threading a middle bolt through the backrest support into the internally threaded central mounting hole; a plurality of side fixing sections made of a material with high rigidity and located outside the middle fixing section for mounting to a rear surface of a backrest of the chair; and an elastically deformable connecting section located between the middle fixing section and each of the side fixing sections. With the elastic connecting sections, the backrest connected to the backrest support via the side and the middle fixing sections is allowed to elastically deflect in multiple directions relative to the backrest support, making the backrest more comfortable for leaning.

### FIELD OF THE INVENTION

The present invention relates to a chair backrest mounting bracket, and more particularly, to a chair backrest mounting bracket that provides excellent elastic deformability and connection strength.

### BACKGROUND OF THE INVENTION

In most conventional chair backrest structures, a substantially flat backrest is directly fixedly connected to a rear edge of a seat or rear ends of two armrests of the chair. Alternatively, the backrest is mounted to a backrest support upward extended from the seat or the armrests. Therefore, most conventional chair backrests are fixedly or immovably relative to the seat or armrests.

Some other chair backrest structures include an elastically bendable and deformable backrest support upward extended from a rear edge of a seat, so that a chair backrest connected to a top of the backrest support is allowed to incline rearward and therefore more comfortable for leaning. It is noted, however, the chair backrest is connected to the elastically deformable backrest support via a rigid and non-deformable mounting bracket. When the rigid mounting bracket is completely fixedly mounted to and between the chair backrest and the backrest support, the chair backrest is allowed to bend, that is, to incline forward or rearward, only in an elastic deformation direction of the backrest support. Therefore, the rigid and non-deformable backrest mounting bracket does not allow the chair backrest connected to the elastically deformable support to be comfortable enough to meet users' requirement. On the other hand, when a clearance is left between the rigid backrest mounting bracket and the chair backrest and the backrest support to allow the chair backrest to deflect in more different directions relative to the backrest support, the backrest tends to shake and sway due to incomplete contact with the mounting bracket. Such shaking and swaying backrest would inevitably adversely affect the consumer's trust and interest in the chair.

It is therefore tried by the inventor to develop an improved chair backrest mounting bracket to eliminate the drawbacks in the prior art.

### SUMMARY OF THE INVENTION

A primary object of the present invention is to provide a chair backrest mounting bracket that has good connection strength and allows a chair backrest connected to a corresponding backrest support via the mounting bracket to elastically deflect relative to the backrest support, so that the backrest is more comfortable for leaning and has upgraded competing ability in the market.

Another object of the present invention is to provide a chair backrest mounting bracket that enables firm and stable mounting of a chair backrest to a corresponding backrest support without causing shaking or incomplete contact, so that the chair backrest has improved assembling quality.

To achieve the above and other objects, the chair backrest mounting bracket according to the present invention includes a middle fixing section made of a material with high rigidity and having an axially extended and internally threaded central mounting hole; the middle fixing section being connectable to a predetermined position on a backrest support of a chair by threading a middle bolt through the backrest support into the internally threaded central mounting hole; a plurality of side fixing sections made of a material with high rigidity and located outside the middle fixing section; each of the side fixing sections having a centered and axially extended side mounting hole, through which a side fastening element may be extended into a predetermined position on a backrest of the chair; and an elastic connecting section made of a flexible and deformable material and located between the middle fixing section and each of the side fixing sections, allowing the chair backrest to be elastically connected to the backrest support via the middle and the side fixing sections.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front perspective view of a chair backrest mounting bracket according to a preferred embodiment of the present invention;

FIG. 2 is a vertical sectional view taken on line A-A of FIG. 1;

FIG. 3 shows the use of the present invention to mount a chair backrest to a backrest support;

FIG. 4 is a sectioned side view showing the mounting of a chair backrest to a backrest support via the present invention;

FIG. 5 shows the chair backrest mounted to the backrest support via the present invention is allowed to incline backward; and

FIG. 6 shows the chair backrest mounted to the backrest support via the present invention is allowed to turn sidewardly.

### DETAILED DESCRIPTION OF THE PREFERRED EMBODIMENTS

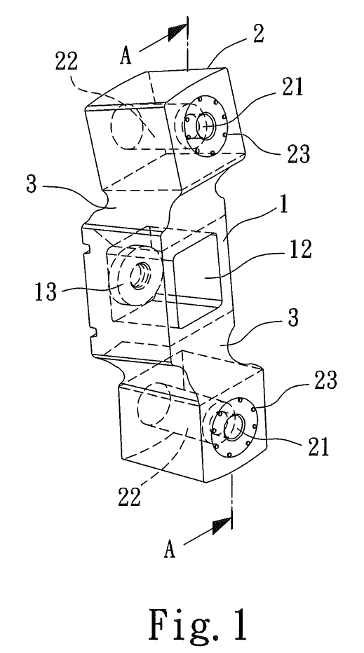

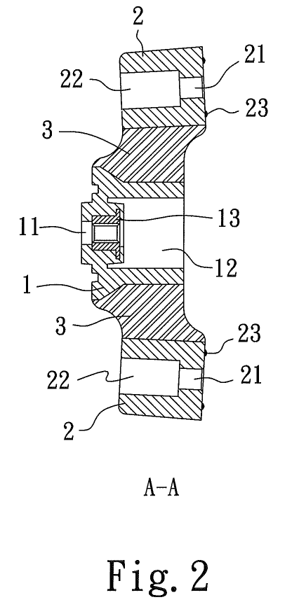

Please refer to FIG. 1 that is a front perspective view of a chair backrest mounting bracket according to a preferred embodiment of the present invention, and to FIG. 2 that is a sectional view taken on line A-A of FIG. 1. As shown, the chair backrest mounting bracket of the present invention includes a middle fixing section 1, a plurality of side fixing sections 2 located outside the middle fixing section 1, and an elastic connecting sections 3 located between the middle fixing section 1 and each of the side fixing sections 2.

The middle fixing section 1 is a hollow structure made of a material with high rigidity, such as a rigid plastic material or a metal material, to define at a rear side an axially extended central mounting hole 11, and at a front side a cavity 12 having a cross section larger than that of the central mounting hole 11. A nut 13 is embedded in the middle fixing section 1 at a joint of the central mounting hole 11 and the cavity 12, such that an internally threaded structure is formed at an inner end of the central mounting hole 11.

The side fixing sections 2 are also made of a material with high rigidity, such as a rigid plastic material or a metal material, to locate outside the middle fixing section 1. In the illustrated preferred embodiment, there are two side fixing sections 2 separately located at an upper and a lower side of the middle fixing section 1. Each of the side fixing sections 2 is a hollow structure defining at a front side a centered and axially extended side mounting hole 21, and at a rear side a spot face 22. A plurality of pointed teeth 23 are spaced on a front end surface of the side fixing section 2 around the side mounting hole 21.

The elastic connecting sections 3 are made of a flexible material with high elasticity, such as a rigid rubber material, to connect the middle fixing section 1 to the side fixing sections 2, so as to provide restorable bending, twisting, or deformation when the middle fixing section 1 and the side fixing sections 2 bear an externally applied force.

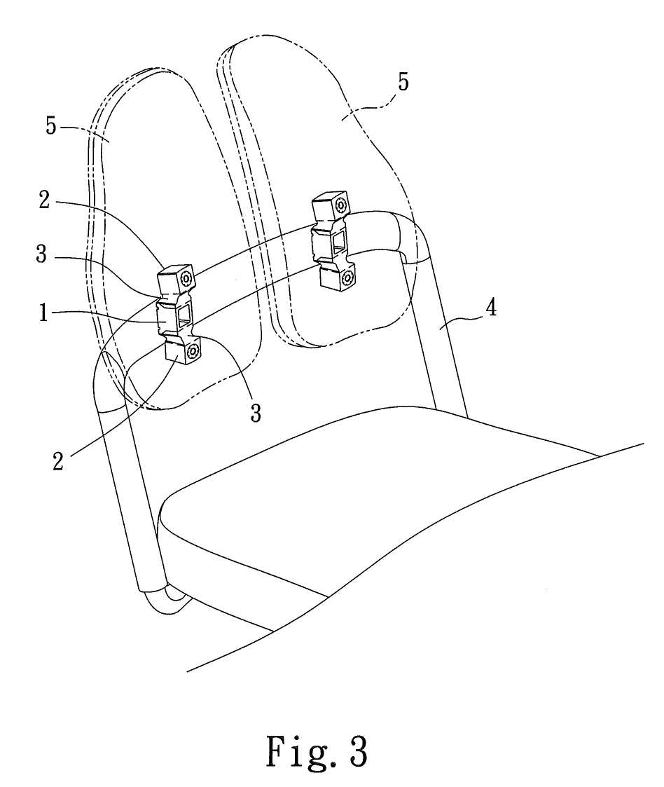

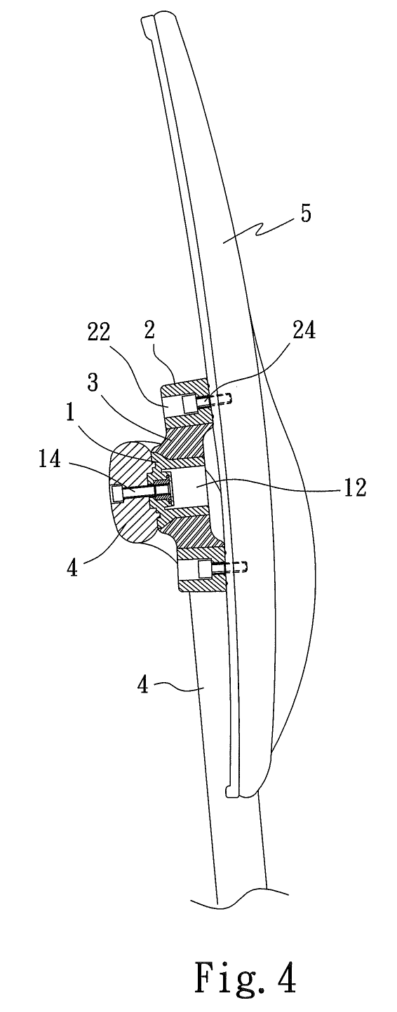

FIGS. 3 and 4 are perspective and sectioned side views, respectively, showing the use of the chair backrest mounting bracket of the present invention to connect a chair backrest 5 to a backrest support 4. As shown, to connect the chair backrest 5 to the backrest support 4 via the mounting bracket of the present invention, first firmly attach the side fixing sections 2 to the chair backrest 5 by piercing the plurality of pointed teeth 23 into a rear surface of the backrest 5 and screwing a plurality of side fastening elements 24, such as bolts, nails, or other functionally equivalent fastening elements, from the spot faces 22 through the side mounting holes 21 into threaded holes correspondingly provided on the chair backrest 5. Thereafter, firmly associate the middle fixing section 1 with a transverse section of the backrest support 4 by extending a middle bolt 14 through a mounting hole correspondingly provided on the backrest support 4 into the nut 13 in the central mounting hole 11 of the middle fixing section 1. As a result, the chair backrest 5 is firmly and stably connected to the backrest support 4 via the side fixing sections 2, the elastic connecting sections 3, and the middle fixing section 1 of the mounting bracket of the present invention.

In the illustrated preferred embodiment, the internally threaded structure is formed in the middle fixing section 1 by embedding the nut 13 in the inner end of the central mounting hole 11. However, the internally threaded structure may be otherwise formed by tapping the central mounting hole 11 directly.

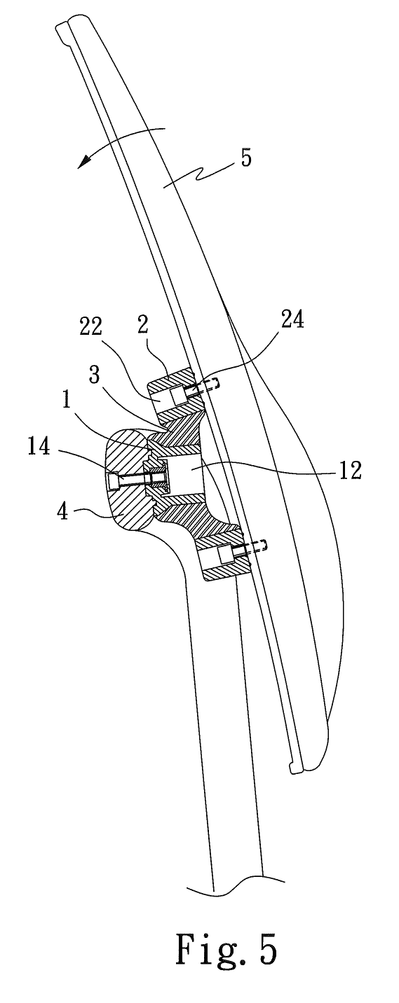

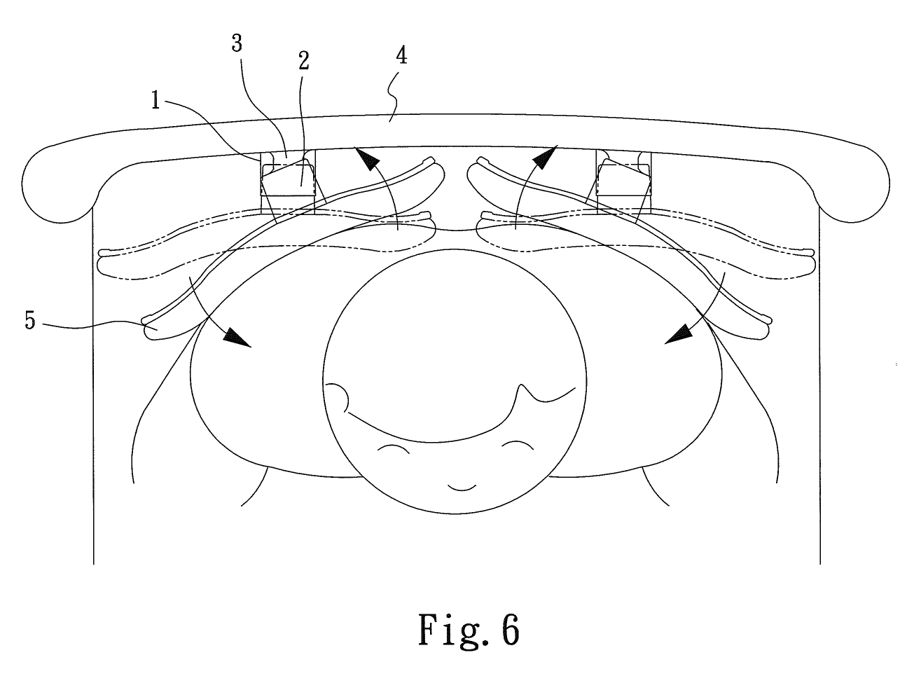

FIGS. 5 and 6 show the chair backrest 5 mounted to the backrest support 4 via the mounting bracket of the present invention is allowed to deflect in different directions relative to the backrest support 4. Since the chair backrest 5 is connected to the side fixing sections 2 and the backrest support 4 is connected to the middle fixing section 1 of the mounting bracket of the present invention, and the middle fixing section 1 and the side fixing sections 2 are connected to one another via the elastically bendable and twistable connecting sections 3, the backrest 5 subjected to an external force is allowed to elastically incline backward relative to the backrest support 4 as shown in FIG. 5, or to elastically turn sidewardly relative to the backrest support 4 as shown in FIG. 6 in response to a user's sitting position. Therefore, the chair backrest 5 is able to provide the most comfortable supporting effect.

The chair backrest mounting bracket of the present invention provides excellent connection strength to enable firm and stable mounting of the backrest to the backrest support while allows the backrest to elastically deflect in multiple directions relative to the backrest support, making the backrest more comfortable for use.

What is claimed is:

1. A chair backrest mounting bracket, comprising:
a middle fixing section made of a material with high rigidity and having an axially extended and internally threaded central mounting hole; the middle fixing section being connectable to a predetermined position on a backrest support of a chair by threading a middle bolt through the backrest support into the internally threaded central mounting hole;
a plurality of side fixing sections made of a material with high rigidity and located outside the middle fixing section; each of the side fixing sections having a centered and axially extended side mounting hole, through which a side fastening element may be extended into a predetermined position on a backrest of the chair; and
an elastic connecting section made of a flexible and deformable material and located between the middle fixing section and each of the side fixing sections, allowing the chair backrest to be elastically connected to the backrest support via the side fixing sections and the middle fixing section.
